(19) United States
(12) Patent Application Publication
(10) Pub. No.: US 2013/0067817 A1
(43) Pub. Date: Mar. 21, 2013

(54) DOOR CONTROL SYSTEM

(71) Applicant: Jesper Sorensen, Vejle (DK)

(72) Inventor: Jesper Sorensen, Vejle (DK)

(73) Assignee: REHABILER & BUSSER A/S, Vejle (DK)

(21) Appl. No.: 13/500,514

(22) PCT Filed: Oct. 7, 2010
(86) PCT No.: PCT/DK2010/000131

§ 371 Date: Dec. 3, 2012

(30) Foreign Application Priority Data
Oct. 8, 2009 (DK) PA 2009 01 107

(51) Int. Cl. E05F 15/20; E05F 15/00

(52) U.S. Cl. CPC E05F 15/20; E05F 15/00; E05F 15/2092; E05F 15/0004
USPC 49/30; 49/340; 49/31; 49/506

(57) ABSTRACT

The present invention relates to door control systems, especially to door control systems for power-controlled swinging doors of a vehicle, wherein the door control system is adapted to control the movement of a door panel being pivotable between a closed position and an open position, and comprising a belt drive system having a belt and two pulleys, a driving element securely connected to the belt, a connection arm pivotally connected to the driving element in one end and adapted to be fixedly connected to the door panel to be controlled in another end, driving means to drive the belt drive system, and a control unit to control the driving means to move the driving element along a predetermined path. The door control system may have an automatic safety stop if an obstruction in the path of the moving door is detected. The vehicle may be a disability-adapted vehicle.

### FIELD OF INVENTION

The present invention relates to door control systems, especially to a door control system for power controlled swinging doors, and furthermore to a door control system providing an automatic safety stop if an obstruction in the path of the moving door is detected. In a further aspect, the invention relates to a door assembly for a vehicle with a ramp, wherein the door(s) are controlled by a door control system as herein described and wherein the door(s) and the ramp may be coordinately controlled. In a particular embodiment, the vehicle is a disability-adapted vehicle.

### BACKGROUND OF THE INVENTION

Automatic door assemblies of both the sliding door type and the swinging door type are well-known in the art.

The use of endless chains being passed over chain wheels is known from sliding doors where the door panels are guided along two edges. EP 0454261 provides an example of an overhead sliding door being guided in vertical guiding rails on either side of the door panel and wherein the door panel is operated by exerting a pulling/pushing force on the door panel via the chain in a direction substantially parallel to the movement of the endless chain. The guiding rails ensure that the door panel is moved in the desired direction, to the desired position.

For swinging door assemblies, where the doors are not guided in guiding rails, typically an articulated or telescopic arm is connected between the door panel and an output of a driving means, such as a small rotary motor. The rotary motion of the output pivots the articulated arm, and this pivoting movement is then translated into a swing motion of the door panel.

Alternatively, the door may be controlled by linear actuators and/or telescopic arms.

EP 1 854 953 discloses an automatic door system, wherein one end of a telescopic door arm is fixedly connected to the rotary output of a motor and the other end is pivotally connected at a fixed point of the door panel. When powered, the motor will pivot the door arm to move the door panel and the telescopic arm will increase or decrease in length to accommodate for the movement of the door panel.

However, especially when opening and closing heavy cargo doors, this system exerts strong forces on the pivoting telescopic arm, making the system vulnerable for misalignments. The designs suggested in the prior art are bulky, takes up too much space and pose a risk of getting caught in arm connections or pivot points.

It is an object of the present invention to provide an improved door control system for automatic control of door panels, especially of pivotably mounted vehicle doors.

### SUMMARY OF THE INVENTION

The above and other objects are fulfilled by a door control system according to a first aspect of the invention wherein the door control system is for use in a vehicle having at least one door panel pivotably connected to a vehicle frame, and being movable about a pivoting axis between a first closed position and a second open position, the door control system comprising
a belt drive system having a belt and at least a first and a second pulley,
a driving element being securely connected to the belt, driving means to drive the belt drive system, and
a control unit to control the driving means to move the driving element along a mainly linear path,
   a connection arm having a first end pivotably connected to the driving element and a second end connectable to the door panel, wherein the driving element and the connection arm cooperate to pivot the door panel about the pivoting axis when the driving element is moved along the mainly linear path.

The control unit, thus, controls the driving element to move the connection arm, and thereby control the movement of the door panel when the connection arm is mounted to the door panel.

The door control system is preferably a door control system to be used in vehicles to control the vehicle door panels. Typically, the door panels are attached to a frame of the vehicle, such as a frame surrounding an opening towards either a side of a vehicle or towards the rear of a vehicle. However, the frame may also be any other frame for holding a door panel. The door panel may be connected to the frame, such as the vehicle frame, in any known manner, such as in a hinged or otherwise pivotable manner. The door panel may be connected to the frame along either a side of the frame or the door panel may be connected on a top or bottom side of the frame. To close the opening, there may be more than one door panel in a frame, and, typically, two door panels are provided for hinged cargo doors, even though also a single side or top mounted hinged door panel may be used.

The vehicle may be any type of vehicle, such as a car, a truck, a bus, a van, such as a cargo van. In a preferred embodiment, the vehicle is a disability-adapted vehicle, a handicap vehicle, a wheelchair vehicle, or a wheelchair accessible vehicle. Furthermore, the vehicle may be any vehicle equipped with a ramp or lift.

In a second aspect of the invention, a door assembly system for use in a vehicle having a first and a second pivotable door panel connected to a vehicle frame of said vehicle and being movable about a pivoting axis between a first closed position and a second open position, is provided, comprising a first door control system for controlling the first door panel, and a second door control system for controlling the second door panel, each door control system comprising
a belt drive system having a belt and at least a first and a second pulley,
a driving element being securely connected to the belt,
driving means to drive the belt drive system, and
a control unit to control the driving means to move the driving element along a mainly linear path,
a first and a second connection arm each having a first end pivotably connected to the driving element and a second end connectable to the first and second door panel, respectively, wherein the driving element and the connection arm cooperate to pivot the door panels about the pivoting axis when the driving elements are moved along the mainly linear paths, and wherein the control unit of the first door control system and the control unit of the second door control system cooperate to allow a time lag between a “start opening time” of the first door panel and a “start opening time” of the second door panel to be software controlled.

Thus, the door control system allows for the second door panel to initiate an opening cycle before the first door panel has stopped moving. This feature provides a reduced opening time even when the door panels may be controlled to move at a reduced speed.

In a third aspect of the invention an access system for a vehicle is provided, wherein the vehicle has one or more swinging door panels, and a door control system for each of the one or more swinging door panels adapted to control the movement of the one or more door panels being movable between a closed position and an open position, and a ramp system and a ramp control system, the one or more door control systems each comprising a belt drive system comprising a belt and at least a first and a second pulley, a driving element being securely connected to the belt, a connection arm having a first end pivotally connected to the driving element and a second end adapted to be fixedly connected to the door panel to be controlled, driving means to operate the belt drive system, and a control unit to control the driving means to move the driving element along a predetermined mainly linear path, the ramp system comprising a lift movable between a stowed position and an exterior access position and being controlled by the ramp control system, wherein the ramp control system and the one or more door control systems communicate to exchange door status signals and ramp status signals.

The driving means are preferably connected through power transferring means, such as a shaft or an axle, with one of the pulleys to drive the pulley and thereby the belt drive system.

In a further aspect of the invention, a vehicle is provided, wherein the vehicle comprises one or more door panels, a door control system according to the first aspect of the invention for each of the one or more door panels, and further comprises a ramp and a ramp control system, and a connection between the ramp control system and each of the one or more door control systems for exchanging door status signals and ramp status signal. The connection between the ramp control system and each of the one or more door control systems may be formed via a vehicle bus system so that the door control systems and the ramp control system communicate via a vehicle control system, such as a vehicle bus system. Alternatively, the door control system(s) and the ramp control system communicate through a separate system.

In a preferred embodiment the door control system and the ramp control system is one control system controlling the ramp and the door panel(s).

In a further aspect of the present invention, a method of automatically operating the entry/exit point of a disability-modified vehicle is provided, wherein the vehicle has at least one power door panel and a vehicle installed power ramp, the method comprises the steps of

initiating an opening cycle by activating a door control system according to the first aspect of the present invention, whereby the at least one power door panel opens,
providing a door open signal to a ramp control system when the at least one power door panel is opened,
receiving the door open signal by the ramp control system to activate the power ramp,
unfolding the power ramp to an exterior access position,
initiating a closing cycle by activating a ramp control system, upon which the power ramp is stowed,
providing a ramp stowed signal to the door control signal when the ramp is stowed,
initiating a closing cycle upon receipt of the ramp stowed signal, and closing the door panel(s).

In a further embodiment of the invention, the door control system further communicates with the vehicle systems to provide e.g. a door closed signal to the vehicle bus system. Furthermore, the door control system(s) and the vehicle control system may communicate to exchange a number of data, such as for example but not limited to data relating to the speed of the vehicle, the position of an automatic transmission, a hand brake signal, etc, so as to e.g. allow the door to open only when the vehicle is not moving, when the handbrake is engaged, and/or when the automatic transmission is in the park position, etc. Furthermore, data may be exchanged between the vehicle anti-theft system and the door control system to e.g. allow for activation of the door control system only after authorization.

It is a disadvantage of some of the presently available systems, that connections between door panel(s) and driving system(s) are bulky and often possess a safety concern as objects, such as fingers, loose clothes etc. may be caught in the moving and pivoting parts.

Accordingly, the door control system of the present invention provides a simplified connection between the door control system and any given door panel. In effect, a connection arm, such as an elongated connection member, preferably a rigid connection arm, may form the connection. One end of the connection arm is pivotally connected to the driving element and the other end is adapted to be fixedly connected to the door panel to be controlled. It is preferred that the arm is a rigid arm without interconnections, joints, hinges or telescopic features.

The driving element may be movable between a first driving element position adjacent the first pulley and a second driving element position adjacent the second pulley. Preferably, this movement corresponds to moving a door panel controlled by the door control system via the driving element, from a first closed position to a second open position or vice versa. The degree to which the door panel can be opened, may be adjusted either by adjusting the vertical position of the door panel connection point at which the connection arm is attached, or by controlling the distance the driving element can move, either electronically via the door control system, or by controlling the distance between the first and second pulleys at the time of assembly.

Preferably, the driving element is securely attached to the belt, and may be secured by any method known in the art. In a preferred embodiment, the driving element is bolted to the belt. The driving element and the belt drive system may be connected so as to provide for a primary movement of the driving element along a linear path between the first and the second pulleys. In a further preferred embodiment, the driving element and the belt drive system may be connected so as to provide for a secondary movement of the driving element along a curved path, such as e.g. following a path around the first and/or second pulley.

Especially for swinging doors, it is preferred that the door control system is mounted so as to allow for the linear path to follow a direction which is substantially perpendicular to the door panel to be controlled when the door panel is seen in the closed position. However, the door control system may also be mounted so that the linear path follows another direction at any angle to the door panel to be controlled, when measuring the angle with the door panel being in the closed position.

It is known in the art that the sudden stopping of automatically opening or closing doors provide a shaking of the doors when they reach their end positions. In a preferred embodiment of the present invention, the control unit is a programmable software controller. To e.g. minimize the shaking, the driving means may be programmed to control the driving element to move at a different, such as at a slower, velocity in a starting period and an ending period of each opening and closing cycle. For example, the driving means may control the driving element to move at first velocity during the linear path and at a second velocity during the curved path. However, as the driving means are software controlled, they may be programmed to follow any predetermined velocity curve, thus also the length of the beginning period and the end period may be adjusted, and preferable, the length of the periods are adjusted according to the specific application. Hereby, the door panels may for example open or close at a velocity tolerable for a user and slow down towards the end of the movement, thus reducing the shake. Preferably, the speed is gradually ramped down in the end period and gradually ramped up in the starting period.

To close a door tightly, typically extra force is needed toward the end of the movement of the door panel to ensure that closing elements in the door panel and closing elements in the frame snap correctly into contact. However, with the door control system according to the present invention, the complete closing is ensured in that the control unit applies the force or the power necessary to close the door tightly by moving the driving element to a predetermined position, a position where the door is known to be locked tightly.

It is, thus, a further advantage of the door control system according to the present invention that the door control system allows for engagement of any door closing features present in the door panel and the frame, such as e.g. manufacture installed closing features, by proper adjustment and installation of the door control system, so that leaking doors and wind noise from not completely closed doors is substantially avoided.

A further advantage of driving the element at least partly around the pulley, relative to the linear path, is that a self-locking effect is obtained. The self-locking effect is obtained in that the driving element is movable between a first driving element position adjacent the first pulley and a second driving element position adjacent the second pulley, wherein the first and/or second driving element positions are arranged in such a way that when the driving element has passed around the first and/or second pulley, the driving element is stopped only after a point on the path at an axis extending parallel to the linear path of the belt and through the centre point of the corresponding pulley is traversed.

When the driving element is driven around the pulley, a simple pull function in e.g. the connection arm, will not release the driving element, similarly will neither a simple push function move the driving element from the self-locked position.

The belt drive system may be any belt drive system as known in the art, and the belt may be a flat belt, a v-belt or in a preferred embodiment a toothed belt. It is preferred that the belt is guided, and the belt may for example be guided between an upper and a lower plate, and it is furthermore preferred that the driving element as mounted on the belt is guided in a guide track, such as a in a guide track provided in at least one of the plates. In a further preferred embodiment, the guide track extends entirely through one or more of the guiding plates, and the driving element may protrude through the plate in the track. Hereby, the first end of the connection arm may be pivotally connected to the part of the driving element protruding through the upper and/or lower plate. It is an advantage of having the driving element protruding through the guiding plates, that the guiding plates may then furthermore serve as at least a part of a shielding case and/or additional shielding may be provided to shield the belt drive system, without interfering with the connection arm.

The driving means preferably comprises a motor, such as a geared motor, such as a rotary motor, such as preferably a reversible motor. This motor may furthermore comprise an encoder; the motor may be a servomotor or any other suitable motor. In a preferred embodiment, the motor is a 12V dc motor capable of using a vehicle provided power as power supply. The motor is preferably adapted to the specific application so that the motor has sufficient torque to control the doors satisfactorily. The motor may comprise a control unit controlling the motor.

In a preferred embodiment of the present invention, the belt is a toothed belt and the driving means controlling the belt drive system comprises an encoder. The door control system may further comprise sensor means for measuring or sensing one or more positions of the driving element. It is thereby possible to more precisely control the movement and the speed of the driving element. Preferably, the one or more positions sensed by the sensor comprises the first driving element position adjacent the first pulley, corresponding to a closed door panel.

The sensor means may be any sensor for sensing position, such as a mechanical sensor, an optical sensor, an electro-magnetic sensor, etc.

The control unit may, thus, control the speed of the motor to control the speed of the driving means which in turn controls the speed of the driving element.

As with any automatic doors, the safety issue is often whether any object, such as items, things, or people may get caught in or get hit by a moving door panel. In the art, many sensing elements, especially photonic sensor/detector systems have been used to secure that door panels re-open or stop if an object is detected either between two door panels or between a door panel and a frame. However, these systems also have disadvantages, and are in many applications, and especially for swinging doors, not sufficiently reliable.

Therefore, in a preferred embodiment of the present invention, the control unit monitors the speed of the belt and thus of the driving element via the encoder. That is, the frequency of the encoder pulses is continuously monitored, so that changes in the speed of the driving element are immediately detected. The advantage of monitoring the speed of the driving element is that even a minor resistance will cause a change in speed, and thereby trigger a stop signal to be send from the control unit to the driving means, thereby stopping the movement of the driving element and thus the movement of a door panel connected to the driving element via the connection arm. Alternatively or additionally, the stop signal triggers a reversing motion of the control unit to retract the door panel from any object encountered. The sensitivity of this safety feature may be controlled by software, so that the change in speed required before a stop signal is sent may be set to an appropriate number of pulses/second for the specific use. Typically a sensitivity may be specified to between 1 and 30 pulses/second, e.g. such as between 10 and 20 pulses/second.

The door control system may furthermore be adapted to provide a first output signal when the driving element is in the first driving element position and/or a second output signal when the driving element is in the second driving element position corresponding to a “door panel closed” signal when the driving element is in the first position and a “door panel opened” signal when the driving element is in the second position. In a preferred embodiment, the position sensor is positioned next to the first driving element position and providing the door panel closed signal when the driving element passes the position sensor. The door panel opened signal may be provided by the control unit when a predetermined amount of pulses has been received, or alternatively the door opened signal may be triggered by a second position sensor adapted to provide a door open signal when the driving element is in the second driving element position.

The door control system may further comprise a case shielding the belt drive system and the upper and lower plate guiding the belt may form at least a part of such a casing.

To enable operation of a connected door panel also when there is no electrical power, a safety arrangement is provided. It may be a safety arrangement enabling the connection arm to be manually disconnected from the driving element e.g. in case of power failure so as to be able to open the door. In a preferred embodiment, the belt drive system additionally or alternatively comprises means for manually driving the driving means, for example by way of extending a driving axle of the pulley driven by the driving means beyond the belt drive system casing and forming at least part of the driving axle protruding from the belt drive system casing so as to provide for a gripping surface for e.g. a spanner or a wrench. Hereby, the belt drive system can be manually driven to any given position so as to either open or close an attached door panel entirely by way of rotating the driving axle.

In a preferred embodiment, the door control system is mounted in a vehicle for controlling the movement of one or more swinging vehicle door(s).

It is an advantage of having the safety arrangement positioned in close proximity to the door control system in the vehicle, so that e.g. a wheel chair user may operate the safety arrangement both on entering and exciting the vehicle.

In another aspect of the present invention there is provided a vehicle having at least one swinging rear door, and a door control system as described above for each swinging rear door.

The door control systems provided for each door are preferably interconnected as to allow for communication between the provided door control systems.

The vehicle may further comprise a ramp and a ramp control system, wherein the at least one swinging door and the ramp are being controlled by the at least one door control system and the ramp control system, respectively, and wherein the at least one door control system and the ramp control system communicate so that the ramp can only be unfolded when a signal is received from the door control system(s) indicating that the swinging door(s) are open, and so that the door control system(s) can only initiate a closing cycle when a signal is received from the ramp control system that the ramp is stowed.

It is envisaged the door control system and the ramp control system may be one control system.

Typically, when automatically opening/closing a set of swinging doors, one door panel must be opened/closed entirely before the second door panel opens/closes. It is an advantage with the door control system according to the present invention that the interconnected door control systems may communicate so as to allow for a vehicle having first and second swinging rear door panels to allow the second door panel to start moving while the first door panel is still moving or vice versa.

It is a further advantage of the present invention that the door control system is software controlled and allows for a set of parameters to be determined upon mounting of the door control system in a specific application. Preferably, the parameters are entered via an interface system having a display. The interface system may be permanently connected to the door control system, or the interface system may be connectable to the door control system e.g. during service of the vehicle. The parameters may be further adjusted after installation. The parameters may include motor speed, motor speed in a starting period and an ending period, e.g. in the form of a ramping of the speed, displacement, i.e. the time delay between primary and secondary door panel, choice of primary door panel and safety monitor sensitivity, but it is envisaged that also other parameters may be determined and/or adjusted.

### BRIEF DESCRIPTION OF THE DRAWING

In order that the invention may be better understood, preferred embodiments will now be described by way of example only, wherein

FIG. 1a shows a picture of a vehicle according to one aspect of the present invention and FIG. 1b shows a schematic diagram of said vehicle,

FIG. 2 shows a door control system according to the present invention in an exploded view,

FIG. 3 shows a schematic view of a door control system according to the present invention,

FIG. 4 shows a cross section of the door control system in FIG. 3,

FIG. 5 shows the sectional view A-A of FIG. 4,

FIG. 6 shows the sectional view B-B of FIG. 4,

FIG. 7 shows a connection arm according to the present invention,

FIG. 8 shows a ramp having a door control system according to the present invention mounted at each side,

FIG. 9a shows a ramp with a door control system at each side, and FIG. 9b and FIG. 9c show the sectional views A-A and B-B, respectively, and

FIG. 10 shows a screen print of a door control system set-up screen.

### DETAILED DESCRIPTION OF THE DRAWING

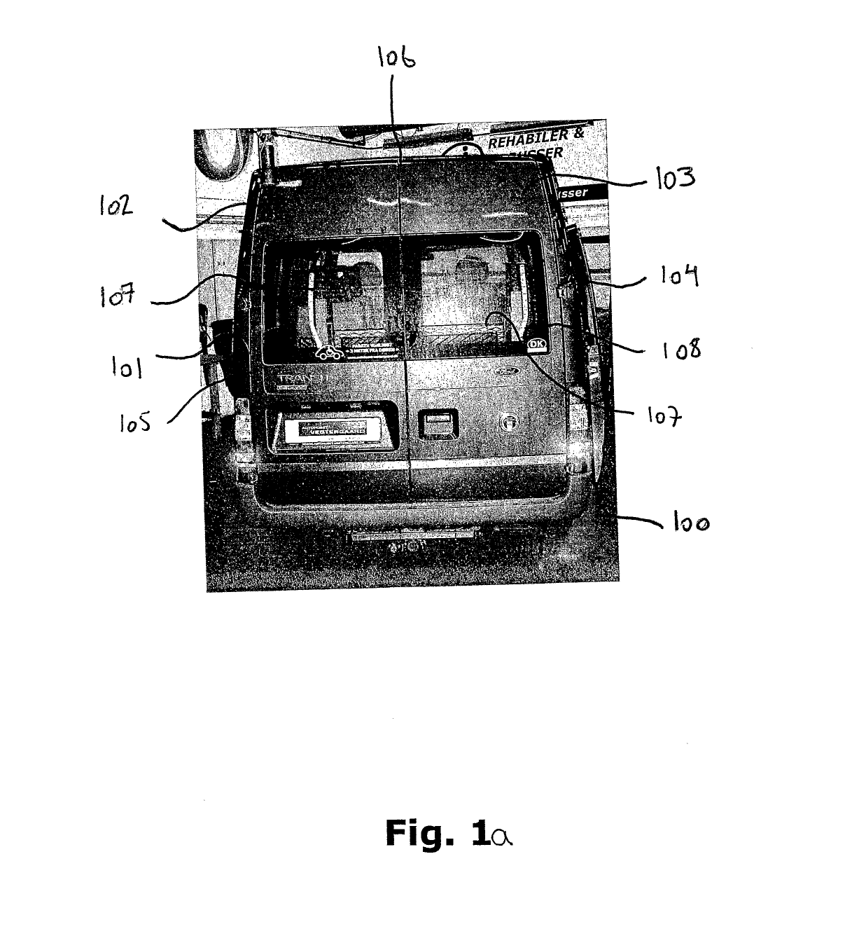

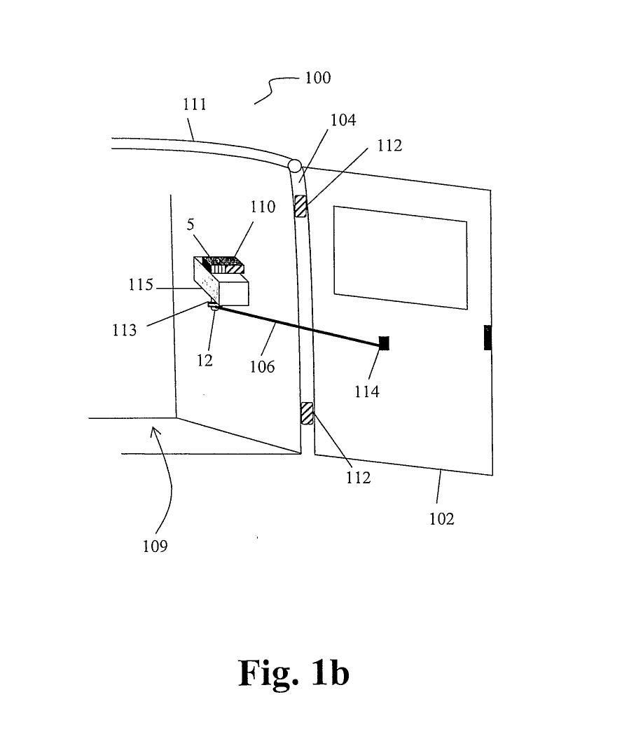

FIG. 1 shows a picture of a vehicle 100 according to one aspect of the present invention. The vehicle 100 in this embodiment is a cargo van having a set of rear cargo doors. Cargo doors typically are of two types: swing-open doors and overhead doors. An exemplary swing-open door system includes a door frame 101 and an opening (behind the doors, not shown) that provides access to the cargo area. A pair of door panels 102, 103 is positioned within the opening. The doors 102, 103 are each hinged on one vertical side 104, 105 (the exterior side) such that the doors open outward. The doors possess roughly the same dimensions and are configured such that, when swung closed, they meet in a vertical seam either in the middle 106 (50/50) of the opening or to a side (60/40), depending on the doors. A door control system 108 controls the door panels. A ramp 107 for accessing the car with a wheelchair is seen in the vehicle 100 in a stowed position.

To open the doors and allow entry/exit from the vehicle, first an opening cycle is initiated by activating (open) the door control system 108 whereby the first power door panel 102 starts opening. After a short delay, measured in time or pulses, the second door panel 103 starts opening. The speed of the door panel 102, 103 accelerates from zero to a predetermined door speed. When the door panels 102, 103 reach the ending period of the opening cycle, the speed is decreased from the predetermined speed to zero when the door panels 102, 103 reach their fully opened end position. When the door panels 102, 103 are fully opened, a door open signal is provided to a ramp control system 108 and after receiving the door open signal, the ramp control system 108 activate the power ramp 107, and unfold the ramp 107. Likewise, the door panels close when the ramp is fully stowed. After initiating a closing cycle by activating a ramp control system, the ramp is stowed, and when the ramp is fully stowed, a ramp stowed signal is provided to the door control signal. The door panels 102, 103 close after activation (close) of the door control signal and if applicable after receiving the ramp stowed signal from the ramp control system. The second door panel 103 accelerates from zero to the predetermined speed during the starting period and after a short delay, the first door panel 102 starts the closing cycle and accelerates from zero m/s to the predetermined speed. The second door 103 reaches the ending period first and the speed of the second door panel is decreased and reaches zero when the door is fully closed and corresponding for the first door 102, where after the door panels 102, 103 are closed.

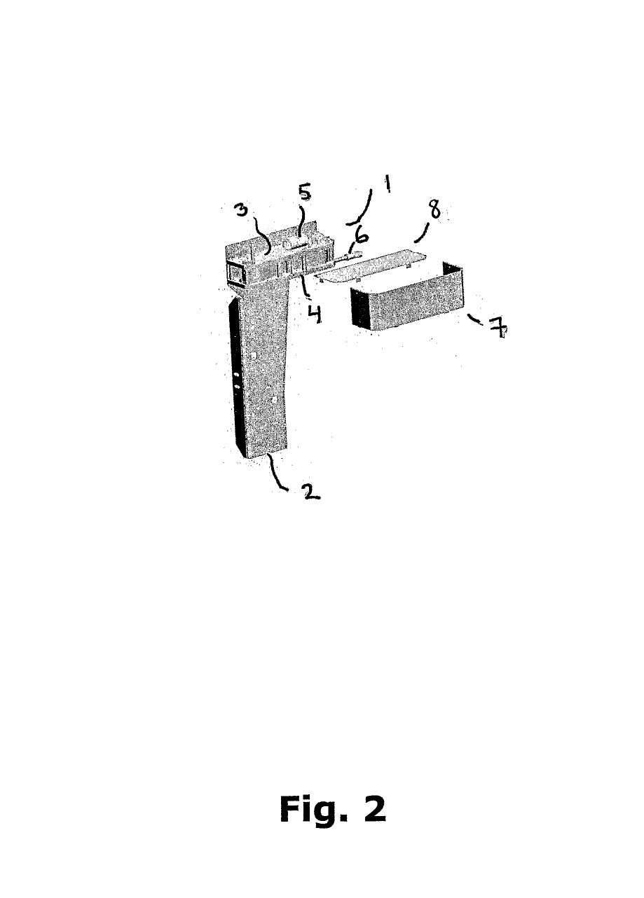

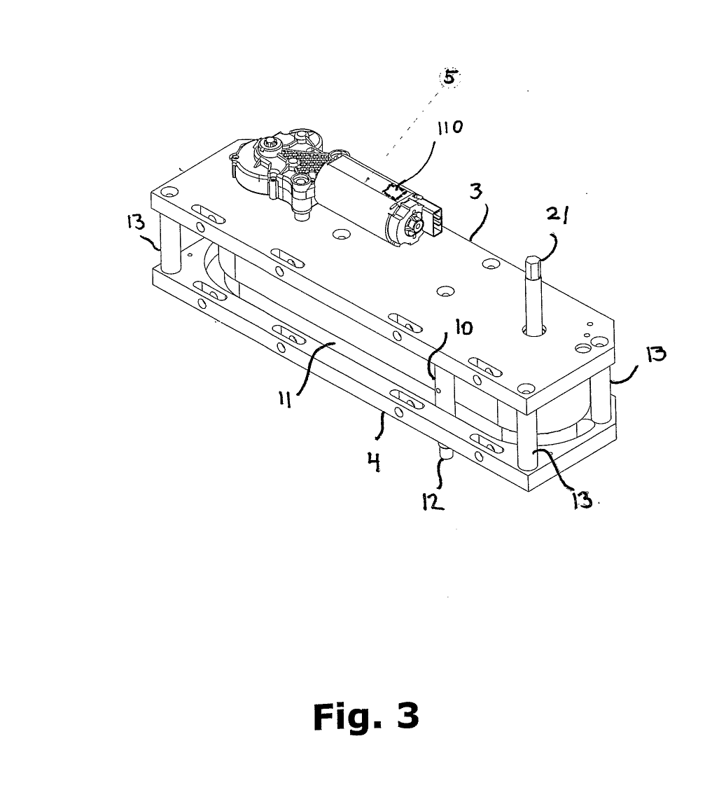

FIG. 1b shows schematically the rear of the vehicle 100 with one door panel 102 open. The door panel 102 is hinged on one vertical side 104 of the vehicle frame 111 via hinges 112 and pivotable about an axis passing through the two hinges 112. Through the door opening 109 surrounded by vehicle frame 111, is the door control system 1 seen. The door control system may be mounted on the inner side of the vehicle as seen in FIG. 1b, or it may be mounted on a ramp system, as seen in FIG. 1a. The driving means 5 and the control unit 110 are positioned on top of the cased belt drive unit 115, and here shown as separate units, but as seen in FIG. 3, the driving means 5 and the control unit 110 may form one entity. The connection arm 6 is seen mounted pivotally to the part 12 of the driving element 10 protruding below the casing 115 of the belt drive unit in one end 113 and fixedly mounted on the door panel in the other end 114. In FIG. 2, an exploded view of a door control system 1 according to the present invention is shown mounted on a mounting base 2. The upper plate 3 and the lower plate 4 guide the toothed belt, and the motor 5 comprising the control unit (not shown) drives the belt. The mounting base is a made of sheet steel and the upper and lower plates are made of a durable plastic such as POM. The connection arm 6 is mounted on the driving element 10. The device is shielded by a shield having a side cover 7 and a lid 8. The lower plate 4 is seen to form part of the shielding.

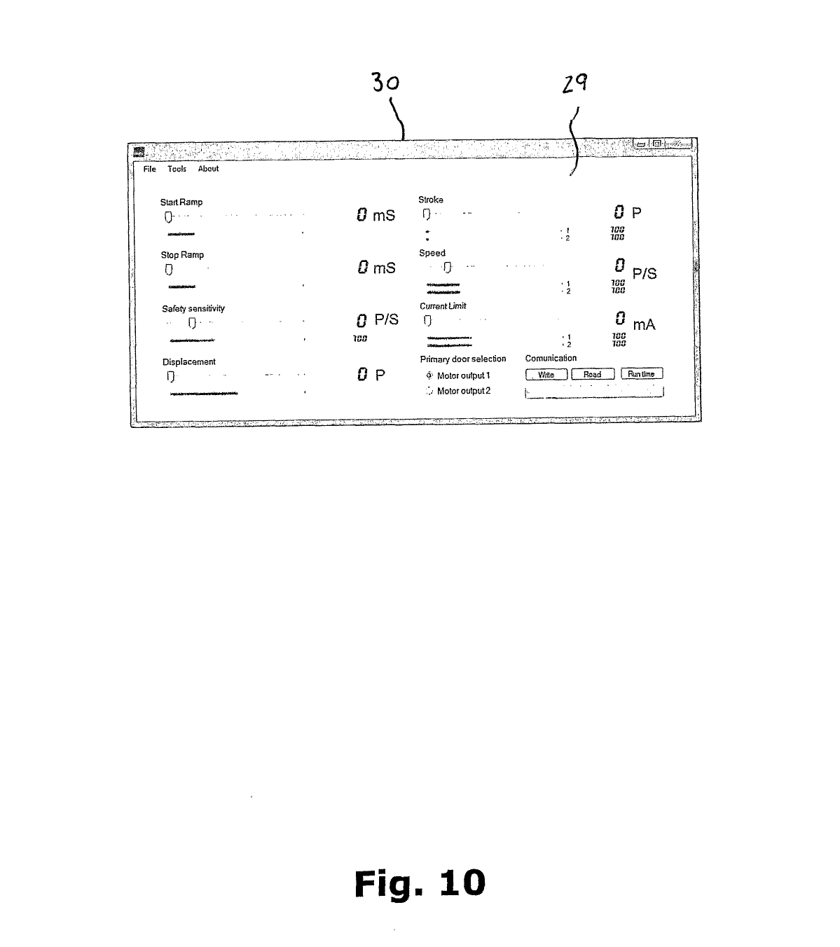

FIG. 3 shows a schematic view of the door control system 1. The driving means 5 is mounted on the upper plate 3 and is a geared 12 V dc reversible motor with encoder. The driving means 5 comprises control unit 110 and has an adapter plug 9 for connection with an interface system for setting and/or adjusting given parameters (see FIG. 10). The upper plate 3 and lower plate 4 are connected with poles 13. The driving element 10 is guided in a guiding track 11 and the part 12 of the driving element protruding below the lower plate 4 is adapted to be pivotically connected to the connection arm (not shown). The motor drives the pulley 14 (see FIG. 5). Shaft 21 of pulley 15 protrudes through the upper plate, and a part of the protruding part is formed to provide a gripping surface for a tool, such as a wrench or spanner to enable manual opening and/or closing of the door e.g. in case of power failure.

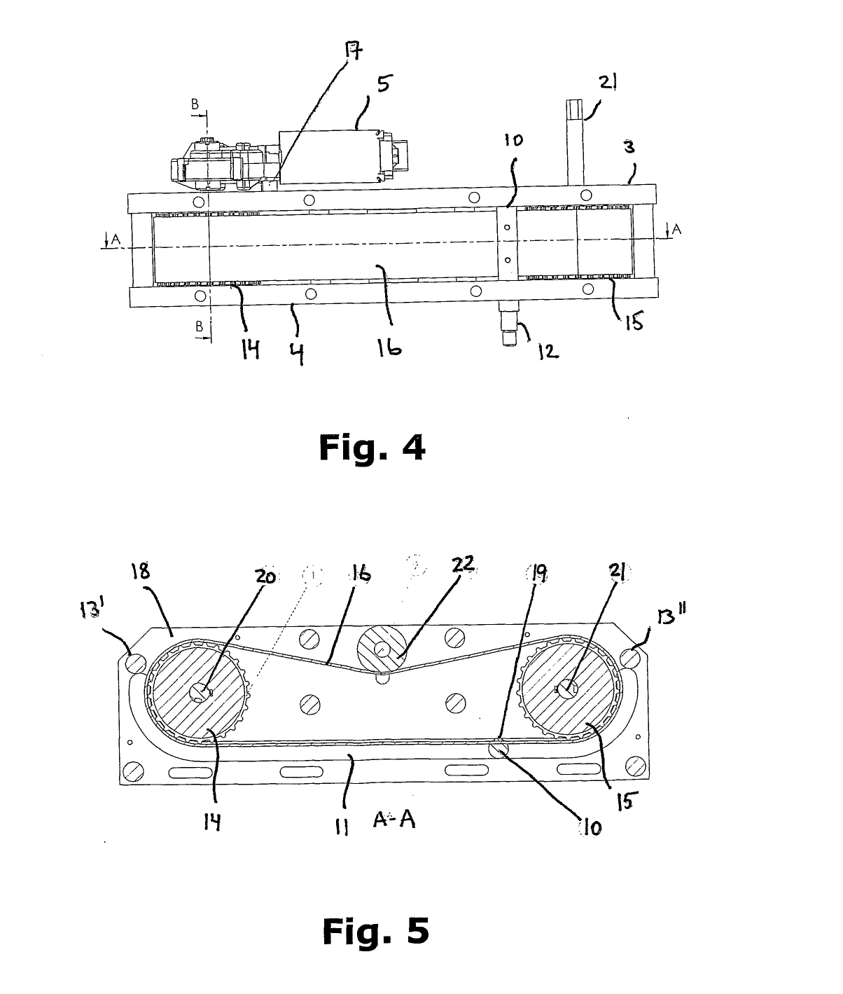

FIG. 4 is a cross sectional view of the door control system shown in FIG. 3. The motor 5 drives the pulley 14 and the toothed belt 16 is mounted around the pulleys 14, 15 and guided between upper plate 3 and lower plate 4. The driving element 10 is securely connected to the toothed belt 16 in that a tooth is removed from the toothed belt and replaced by a metal tooth (not shown in FIG. 4). This metal tooth is then connected to the driving element 10, either by riveting, metallic bonding or another connection method providing a strong bond. The motor 5 is shown connected to the upper plate 3 by a pole 17.

The section A-A of FIG. 4 is shown in FIG. 5. The belt drive system 18 is shown with pulleys 14, 15 and toothed belt 16. Pulleys 14, 15 rotates around shafts 20, 21, respectively, and the tension of the toothed belt 17 is maintained by tension pulley 22 positioned approximately halfway between pulleys 14, 15. The metal tooth 19 is shown bonded with driving element 10 and guided in the guiding track 11. It is seen that poles 13′ and 13″ may further functions as a mechanical stop for driving element 10.

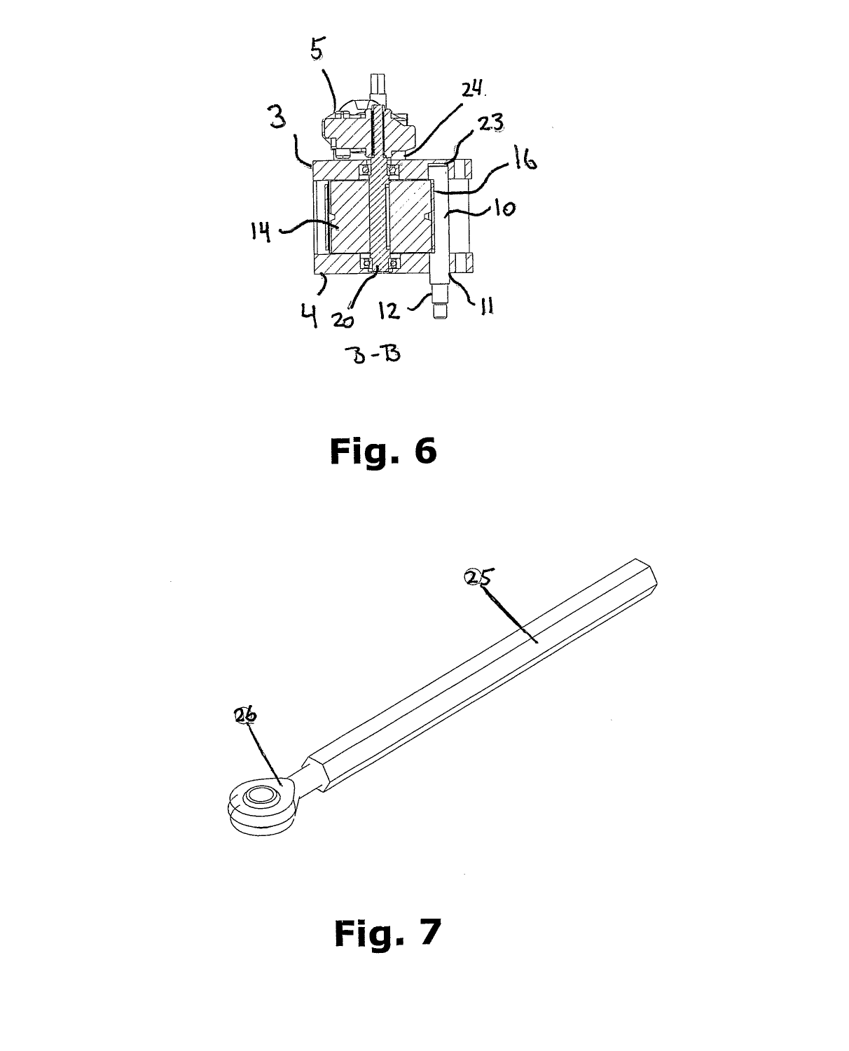

FIG. 6 shows the section B-B of FIG. 4. Pulley 14 is seen between the upper plate 3 and the lower plate 4, and the motor 5 is connected to the pulley 14 via shaft 20. The belt 16 lies around the pulley 14 and the driving element 10 is guided in the guiding track 11 in the lower plate 4 as well as in an upper guiding track 23 in the upper plate 3. Ball bearing 24 is holding the pulley 14.

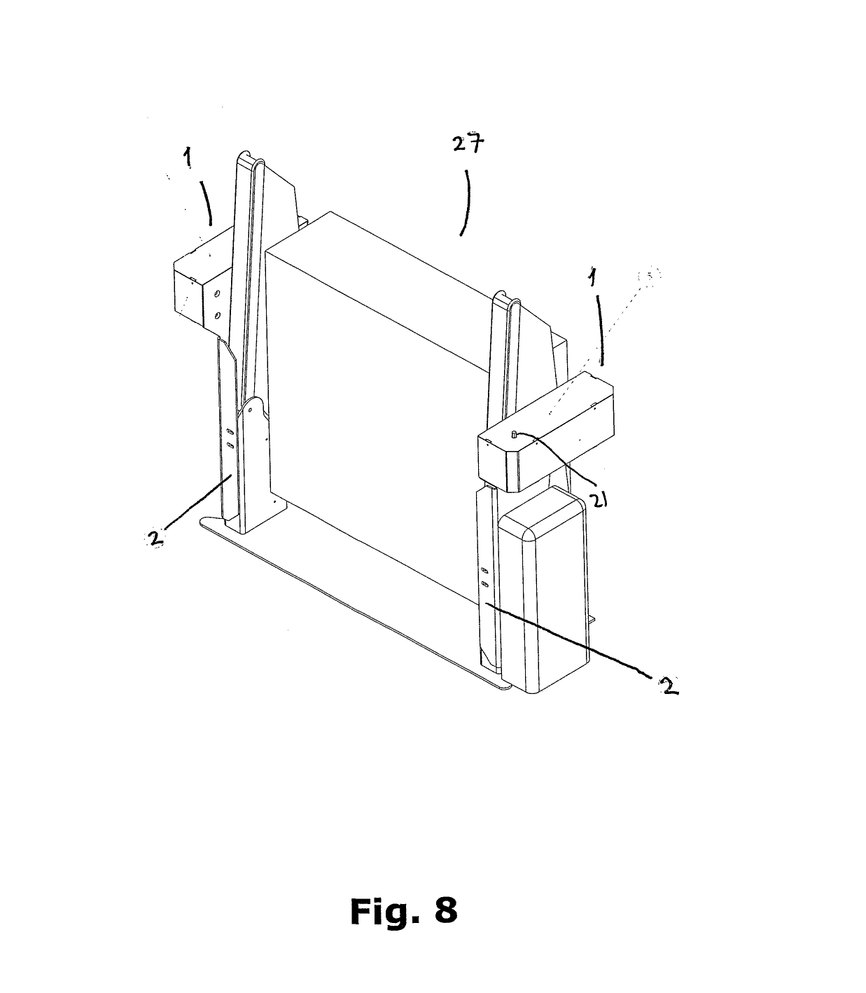

FIG. 7 shows a connection arm 25 according to the present invention. The connection arm has a rod end bearing 26 adapted to be mounted on the protruding part 12 of the driving element. The rod end bearing 26 contains a bearing that can accommodate a shaft or a rod with a certain amount of misalignment. The other end of the connection arm (not shown) is adapted to be connected at a fixed point on the door panel to be controlled.

In FIG. 8, a ramp 27 for being mounted in a vehicle is shown. The ramp 27 has a door control system 1 mounted on each side of the ramp 27, so as to be able to control two swinging doors. The door control systems 1, 1′ are mounted on mounting bases 2, 2′. The ramp 27 is connected to the mounting bases 2, 2′.

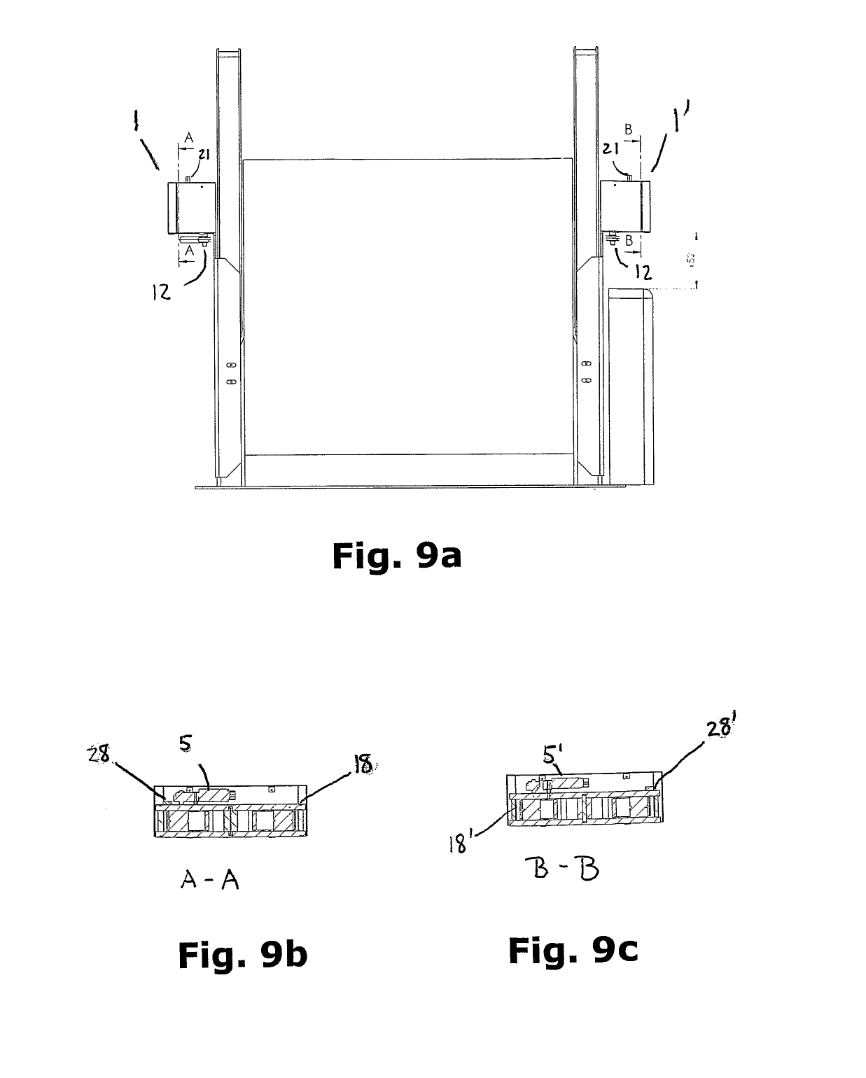

FIG. 9a shows a front view of ramp 27 having a door control system 1, 1′ on each side. Sectional view A-A is shown in FIG. 9b and sectional view B-B is shown in FIG. 9a. The belt drive system 18, 18′, the motor 5, 5′ and the sensor 28 are seen to mirror each other. It is thus possible to produce only one type of door control system and use the same door control systems in both sides of a vehicle by laterally reversing one relative to the other.

In FIG. 10 an exemplary screen print 29 of an interface system having a display 30 is shown. Through the interface systems predetermined parameters can be entered or adjusted. The length of the starting period, in milliseconds, where the speed is accelerated, and the ending period, where the speed is decelerated can be selected by adjusting “Start Ramp” and “Stop Ramp”. Furthermore, the safety sensitivity, i.e. the change in speed the control system registers before performing a safety stop can adjusted by adjusting the “Safety Sensitivity”, which is measured in Pulses per Second, P/S. The “Displacement” is measured in milliseconds and is the delay between the opening of the first door and the opening of the second door. Through the encoder, the speed of the door panels is decreased when the door panels reaches an end position; this “Stroke” is measured in Pulses, P. The predetermined speed of the door panels may be set under “Speed” and the speed is measured in pulses per second, P/S. As a further security measure a “Current Limit” may be set. Also door is to be the primary door, i.e. the door opening first, can be chosen.

While various embodiments of the invention have been described, it will be apparent to those of ordinary skill in the art that many more embodiments and implementations are possible within the scope of the invention.

1. A door control system for use in a vehicle having at least one door panel pivotably connected to a vehicle frame, and being movable about a pivoting axis between a first closed position and a second open position, the door control system comprising
a belt drive system having a belt and at least a first and a second pulley,
a driving element being securely connected to the belt, driving means to drive the belt drive system, and
a control unit to control the driving means to move the driving element along a mainly linear path,
a connection arm having a first end pivotably connected to the driving element and a second end connectable to the door panel, wherein the driving element and the connection arm cooperate to pivot the door panel about the pivoting axis when the driving element is moved along the mainly linear path.

2. A door assembly system according to claim 1, wherein the connection arm is a rigid connection arm.

3. A door control system according to claim 1, wherein the driving means comprises an encoder, the belt is a toothed belt, and wherein the door control system further comprises sensor means for sensing one or more positions of the driving element.

4. A door control system according to claim 1, wherein the control unit monitors a speed of the driving element and wherein a change in speed triggers a stop signal to be sent from the control unit to the driving means, thereby stopping the movement of the driving element at least temporarily.

5. A door control system according to claim 3, wherein the control unit controls the speed of the driving element according to a predetermined function of the driving element position.

6. A door control system according to claim 1, wherein the control unit communicates with a ramp control system controlling a ramp mounted in said vehicle.

7. A door control system according to claim 1, wherein the driving element is movable between a first driving element position adjacent the first pulley and a second driving element position adjacent the second pulley, wherein the first and/or second driving element positions are arranged in such a way that when the driving element has passed around the first and/or second pulley, the driving element is stopped only after a point on the path at an axis extending parallel to the linear path of the belt and through the centre point of the corresponding pulley is traversed.

8. A door assembly system for use in a vehicle having a first and a second pivotable door panel connected to a vehicle frame of said vehicle and being movable about a pivoting axis between a first closed position and a second open position,
a first door control system for controlling the first door panel, and a second door control system for controlling the second door panel, each door control system comprising
a belt drive system having a belt and at least a first and a second pulley,
a driving element being securely connected to the belt, driving means to drive the belt drive system, and
a control unit to control the driving means to move the driving element along a mainly linear path,
a first and a second connection arm each having a first end pivotably connected to the driving element and a second end connectable to the first and second door panel, respectively, wherein the driving element and the connection arm cooperate to pivot the door panels about the pivoting axis when the driving elements are moved along the mainly linear paths, and wherein the control unit of the first door control system and the control unit of the second door control system cooperate to allow a time lag between a “start opening time” of the first door panel and a “start opening time” of the second door panel to be software controlled.

9. A vehicle comprising one or more door panels, a door control system according to claim 1, for each of the one or more door panels, a ramp and a ramp control system, and a connection between the ramp control system and each of the one or more door control systems for exchanging door status signals and ramp status signal.

10. A vehicle according to claim 9, wherein the vehicle has first and second swinging door panels, and wherein the control unit allows the second door panel to start moving while the first door panel is moving or vice versa.

11. An access system for a vehicle, wherein the vehicle has one or more swinging door panels and a door control system for each of the one or more swinging door panels adapted to control the movement of the one or more door panels being movable between a closed position and an open position, and a ramp system and a ramp control system, the one or more door control systems each comprising
a belt drive system comprising a belt and at least a first and a second pulley, a driving element being securely connected to the belt,
a connection arm having a first end pivotally connected to the driving element and a second end adapted to be fixedly connected to the door panel to be controlled,
driving means to operate the belt drive system, and
a control unit to control the driving means to move the driving element along a predetermined mainly linear path,
the ramp system comprising a lift movable between a stowed position and an access position and being controlled by the ramp control system.

12. An access system for a vehicle, according to claim 11, comprising a connection between the ramp control system and the one or more door control system for exchanging door status signals and ramp signal status.

13. A method of automatically operating the entry/exit point of a disability-modified vehicle, the vehicle having at least one power door panel and a vehicle installed power ramp, the method comprising the steps of
initiating an opening cycle by activating a door control system according to claim 1, whereby the at least one power door panel opens,
providing a door open signal to a ramp control system when the power door panels are opened,
receiving the door open signal in the ramp control system to activate the power ramp,
unfolding the power ramp to an access position,
initiating a closing cycle by activating a ramp control system, upon which the power ramp is stowed,
providing a ramp stowed signal to the door control signal when the ramp is stowed,
receiving the ramp stowed signal from the ramp control system to allow for a door closing cycle to initiate,
close the door panels.

14. A method according to claim 13, further comprising the step of operating the door control system via an emergency release knob positioned in close proximity to the door control system.
